(19) United States
(12) Patent Application Publication
(10) Pub. No.: US 2009/0021494 A1
(43) Pub. Date: Jan. 22, 2009

(54) MULTI-MODAL SMARTPEN COMPUTING SYSTEM

(76) Inventors: Jim Marggraff, Lafayette, CA (US); Andy Van Schaack, Nashville, TN (US)

Correspondence Address: FENWICK & WEST LLP, SILICON VALLEY CENTER, 801 CALIFORNIA STREET, MOUNTAIN VIEW, CA, 94041, US

(21) Appl. No.: 12/129,238

(22) Filed: May 29, 2008

Related U.S. Application Data
(60) Provisional application No. 60/940,665, filed on May 29, 2007.

(51) Int. Cl. G06F 3/033

(52) U.S. Cl. 345/179

(57) ABSTRACT

In a pen-based computing system, a smart pen allows user interaction with the pen-based computing system using multiple modalities. Generally, the modalities are categorized as input (or command) modalities and output (or feedback) modalities. Examples of input modalities for the smart pen include writing with the smart pen to provide written input and/or speaking or otherwise providing sound to give audio input to the smart pen. Examples of output modalities for the smart pen include reading visual information displayed by the system, receiving haptic feedback and/or listening to sound played by the system

### CROSS REFERENCE TO RELATED APPLICATIONS

This application claims the benefit of U.S. Provisional Application No. 60/940,665, filed May 29, 2007, which is incorporated by reference in its entirety.

### BACKGROUND

This invention relates generally to pen-based computing systems, and more particularly to a pen-based multi-modal computing system.

Multi-modal systems engage and enhance basic modes of human input and output, such as reading, writing, speaking, and listening. A broad range of multi-modal systems enhance human communication, learning, thought, problem solving, recall, personal productivity, entertainment, commerce, and more. Combining, sequencing, and transitioning modes of human input and output can substantially facilitate and improve tasks and activities in communication, learning, thought, problem-solving, recall, personal productivity, entertainment, commerce, and more.

However, existing systems that support mixed modalities are typically screen-based, expensive, large, have limited portability, and are often non-intuitive. Examples of such systems include personal computers (PCs), personal digital assistants (PDAs), and other dedicated screen-based devices. Conventional multi-modal systems are typically constrained to a single display for visual feedback. In PC-based systems, for example, the display is usually large and consumes substantial power. In cell phone and PDA systems, the screen is relatively small but provides limited visual information. Methods of written input to multi-modal displays are also quite limited. For example, standard PCs require a separate writing input device, tablet PCs require writing on a piece of glass and are expensive, and cell phones and PDAs are not yet responsive enough and/or offer limited writing space. Further writing utensils for use with screen based devices are typically limited to pointing and writing only on the screen based devices. In rare instances where such a pointing device is cross-purposed for writing on both a display and paper, when used to writ on paper, the device is unintelligent, and simply leaves a trail of ink on the paper.

Multi-modal systems are typically built on a general purpose computing or communications tool designed for primary use with a subset of modalities (e.g., some, but not all of reading, writing, speaking, and listening). PCs are not designed to accept written input as a primary use. Most frequently, keying is used in lieu of writing. Writing on a small cell-phone or PDA screen is highly constrained and audio capture hardware and software is often not seamlessly integrated into design of systems. Devices that support and enhance the four basic modes of human communication, reading, writing, speaking and listening, typically also require a screen for the creation of digital ink as a stylus is moved across a screen-surface. They do not interact with pre-printed paper documents, nor do they allow for the creation and interaction with newly handwritten paper documents.

Accordingly, there is a need for a computing platform that uses and enhances the multiple input and output modes of human communication, reading, writing, speaking and listening, in an intuitive and more effective manner and benefits from a design explicitly intended to enhance these modalities. From the platform's perspective, the platform should: 1) display information from a self-contained display and/or interact with information displayed elsewhere (paper, plastic, active display, electronic paper), 2) enable writing on a variety of surfaces, such as ink on paper, ink on a whiteboard and/or interact with an active display via movement across the display, 3) play audio out of a self-contained or connected speaker, 4) capture and/or record audio with a self-contained or connected microphone(s), 5) support and enhance reading, writing, speaking and listening as independent or concurrent modalities, and 6) provide for seamless transitions between independent or concurrent modalities.

### SUMMARY

Embodiments of the invention provide a multi-modal smart pen computing system that enables user interaction with the system in several different modalities. The modalities can be generally categorized into input (or command & capture) modalities and output (or feedback and access) modalities. The input modalities for the smart pen computing system may include writing with a pen-shaped instrument to provide written input and/or speaking or otherwise providing sound to give audio input to the system and/or gesturing input with the smart pen. The output modalities for the smart pen computing system may include reading visual information displayed by the system and/or by pointing or interacting with the smart pen to select externally displayed information on paper or other displays, and/or listening to sound played by the system.

The system should also support concurrent input in the form of simultaneous written and spoken information, where the timing of the two forms of input may provide meaningful information to the smart pen. It should support concurrent output in the form of simultaneous displayed and audio information, where the timing of the two forms of output may provide meaningful information to a user.

The proximity of a display on the smart pen should be close enough to the writing tip of the smart pen to allow a user to seamlessly engage in visual transition between the states of reading from the display and writing on a surface, maintaining visual focus in a small area with minimal eye movement and shift of focus. This supports a user easily viewing the screen on the smart pen, then responding with writing on a surface, moving their eyes easily from screen to surface and back without loss of context.

The presence of a speaker, microphone and display in a pen form factor with a physical writing tip, managed by software, memory and a battery that can activate any input or output mode(s) independently or concurrently, and is capable of seamlessly switching between independent or concurrent input/output modes, represents a new threshold in size, weight, capability, portability and ease of use, of a comprehensive set of components necessary to enable a fully multi-modal, self-contained computing platform.

### BRIEF DESCRIPTION OF THE DRAWINGS

FIG. 1 is a schematic diagram of a pen-based computing system, in accordance with an embodiment of the invention.

FIG. 2 is a diagram of a smart pen for use in the pen-based computing system, in accordance with an embodiment of the invention.

FIG. 3 is a flow chart of providing multiple modalities in a pen-based computing system in accordance with an embodiment of the invention.

The Figures depict various embodiments of the present invention for purposes of illustration only. One skilled in the art will readily recognize from the following discussion that alternative embodiments of the structures and methods illustrated herein may be employed without departing from the principles of the invention described herein.

### DETAILED DESCRIPTION

### Overview of Pen-Based Computing System

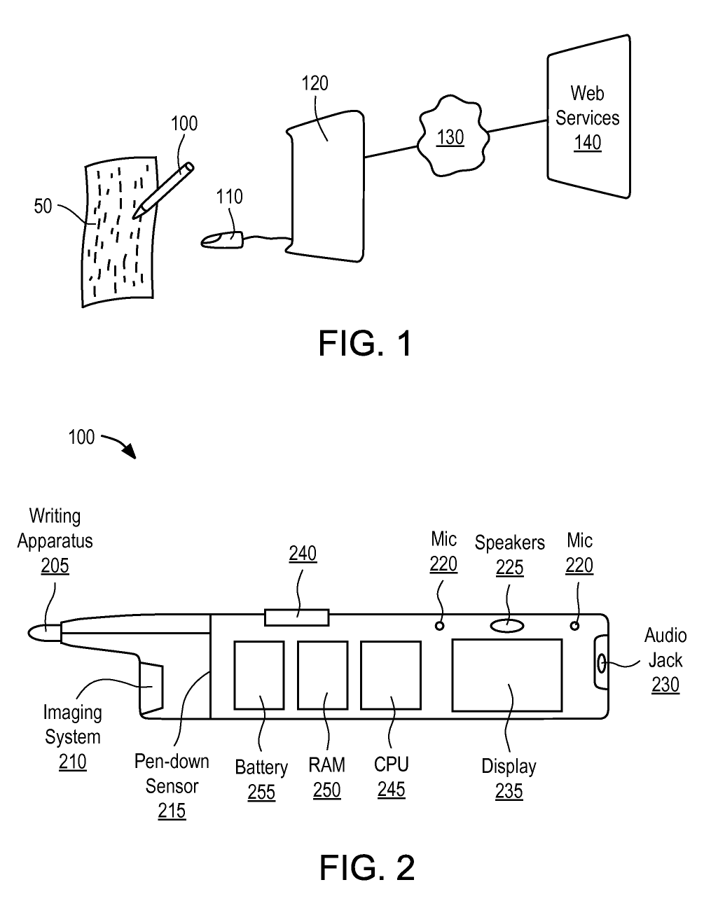

Embodiments of the invention may be implemented on various embodiments of a pen-based computing system, an example of which is illustrated in FIG. 1. In this embodiment, the pen-based computing system comprises a writing surface 50, a smart pen 100, a docking station 110, a client system 120, a network 130, and a web services system 140. The smart pen 100 includes onboard processing capabilities as well as input/output functionalities, allowing the pen-based computing system to expand the screen-based interactions of traditional computing systems to other surfaces on which a user can write. For example, the smart pen 100 may be used to capture electronic representations of writing as well as record audio during the writing, and the smart pen 100 may also be capable of outputting visual and audio information back to the user. With appropriate software on the smart pen 100 for various applications, the pen-based computing system thus provides a new platform for users to interact with software programs and computing services in both the electronic and paper domains, including electronic paper.

In the pen based computing system, the smart pen 100 provides input and output capabilities for the computing system and performs some or all of the computing functionalities of the system. Hence, the smart pen 100 enables user interaction with the pen-based computing system using multiple modalities. In one embodiment, the smart pen 100 receives input from a user, using multiple modalities, such as capturing a user's writing or other hand gesture or recording audio, and provides output to a user using various modalities, such as displaying visual information, playing audio or responding in context to physical interaction such as tapping, tracing, or selecting other pre-existing visual information. In other embodiments, the smart pen 100 includes additional input modalities, such as motion sensing or gesture capture, and/or additional output modalities, such as vibrational feedback.

The components of a particular embodiment of the smart pen 100 are shown in FIG. 2 and described in more detail in the accompanying text. The smart pen 100 preferably has a form factor that is substantially shaped like a pen or other writing implement, although certain variations on the general shape may exist to accommodate other functions of the pen, or may even be an interactive multi-modal non-writing implement. For example, the smart pen 100 may be slightly thicker than a standard pen so that it can contain additional components, or the smart pen 100 may have additional structural features (e.g., a flat display screen) in addition to the structural features that form the pen shaped form factor. Additionally, the smart pen 100 may also include any mechanism by which a user can provide input or commands to the smart pen computing system or may include any mechanism by which a user can receive or otherwise observe information from the smart pen computing system. For example a variety of types of switches including buttons, rocker panels, capacitive sensors, heat sensors, pressure sensors, biometric sensors or other sensing devices could be added.

The smart pen 100 is designed to work in conjunction with the writing surface 50 so that the smart pen 100 can capture writing that is made on the writing surface 50. In one embodiment, the writing surface 50 comprises a sheet of paper (or any other suitable material that can be written upon) and is encoded with a pattern that can be read by the smart pen 100. An example of such a writing surface 50 is the so-called “dot-enabled paper” available from Anoto Group AB of Sweden (local subsidiary Anoto, Inc. of Waltham, Mass.), and described in U.S. Pat. No. 7,175,095, incorporated by reference herein. This dot-enabled paper has a pattern of dots encoded on the paper. A smart pen 100 designed to work with this dot enabled paper includes an imaging system and a processor that can determine the position of the smart pen's writing tip with respect to the encoded dot pattern. This position of the smart pen 100 may be referred to using coordinates in a predefined “dot space,” and the coordinates can be either local (i.e., a location within a page of the writing surface 50) or absolute (i.e., a unique location across multiple pages of the writing surface 50).

In other embodiments, the writing surface 50 may be implemented using mechanisms other than encoded paper to allow the smart pen 100 to capture gestures and other written input. For example, the writing surface may comprise a tablet or other electronic medium that senses writing made by the smart pen 100. In another embodiment, the writing surface 50 comprises electronic paper, or e-paper. This sensing may be performed entirely by the writing surface 50, entirely by the smart pen 100, or in conjunction with the smart pen 100. Even if the role of the writing surface 50 is only passive (as in the case of encoded paper), it can be appreciated that the design of the smart pen 100 will typically depend on the type of writing surface 50 for which the pen based computing system is designed. Moreover, written content may be displayed on the writing surface 50 mechanically (e.g., depositing ink on paper using the smart pen 100), electronically (e.g., displayed on the writing surface 50), or not at all (e.g., merely saved in a memory). In another embodiment, the smart pen 100 is equipped with sensors to sense movement of the smart pen 100 tip, thereby sensing writing gestures without requiring a writing surface 50 at all. Any of these technologies may be used in a gesture capture system incorporated in the smart pen 100.

In various embodiments, the smart pen 100 can communicate with a general purpose computing system 120, such as a personal computer, for various useful applications of the pen based computing system. For example, content captured by the smart pen 100 may be transferred to the computing system 120 for further use by that system 120. For example, the computing system 120 may include management software that allows a user to store, access, review, delete, and otherwise manage the information acquired by the smart pen 100. Downloading acquired data from the smart pen 100 to the computing system 120 also frees the resources of the smart pen 100 so that it can acquire more data. Conversely, content may also be transferred back onto the smart pen 100 from the computing system 120. In addition to data, the content provided by the computing system 120 to the smart pen 100 may include software applications that can be executed by the smart pen 100.

The smart pen 100 may communicate with the computing system 120 via any of a number of known communication mechanisms, including both wired and wireless communications, such as Bluetooth, WiFi, RF, infrared and ultrasonic sound. In one embodiment, the pen based computing system includes a docking station 110 coupled to the computing system. The docking station 110 is mechanically and electrically configured to receive the smart pen 100, and when the smart pen 100 is docked the docking station 110 may enable electronic communications between the computing system 120 and the smart pen 100. The docking station 110 may also provide electrical power to recharge a battery in the smart pen 100.

FIG. 2 illustrates an embodiment of the smart pen 100 for use in a pen based computing system, such as the embodiments described above. In the embodiment shown in FIG. 2, the smart pen 100 comprises a marker 205, an imaging system 210, a pen down sensor 215, one or more microphones 220, a speaker 225, an audio jack 230, a display 235, an I/O port 240, a processor 245, an onboard memory 250, and a battery 255. It should be understood, however, that not all of the above components are required for the smart pen 100, and this is not an exhaustive list of components for all embodiments of the smart pen 100 or of all possible variations of the above components. For example, the smart pen 100 may also employ buttons, such as a power button or an audio recording button and/or status indicator lights. Moreover, as used herein in the specification and in the claims, the term “smart pen” does not imply that the pen device has any particular feature or functionality described herein for a particular embodiment, other than those features expressly recited. A smart pen may have any combination of fewer than all of the capabilities and subsystems described herein.

The marker 205 enables the smart pen to be used as a traditional writing apparatus for writing on any suitable surface. The marker 205 may thus comprise any suitable marking mechanism, including any ink-based or graphite-based marking devices or any other devices that can be used for writing. In one embodiment, the marker 205 comprises a replaceable ballpoint pen element. The marker 205 is coupled to a pen down sensor 215, such as a pressure sensitive element. The pen down sensor 215 thus produces an output when the marker 205 is pressed against a surface, thereby indicating when the smart pen 100 is being used to write on a surface.

The imaging system 210 comprises sufficient optics and sensors for imaging an area of a surface near the marker 205. The imaging system 210 may be used to capture handwriting and/or gestures made with the smart pen 100. For example, the imaging system 210 may include an infrared light source that illuminates a writing surface 50 in the general vicinity of the marker 205, where the writing surface 50 includes an encoded pattern. By processing the image of the encoded pattern, the smart pen 100 can determine where the marker 205 is in relation to the writing surface 50. An imaging array of the imaging system 210 then images the surface near the marker 205 and captures a portion of a coded pattern in its field of view. Thus, the imaging system 210 allows the smart pen 100 to receive data using at least one input modality, such as receiving written input. The imaging system 210 incorporating optics and electronics for viewing a portion of the writing surface 50 is just one type of gesture capture system that can be incorporated in the smart pen 100 for electronically capturing any writing gestures made using the pen, and other embodiments of the smart pen 100 may use other appropriate means for achieving the same function. In an embodiment, data captured by the imaging system 210 is subsequently processed, allowing one or more content recognition algorithms, such as character recognition, to be applied to the received data.

In an embodiment, data captured by the imaging system 210 is subsequently processed, allowing one or more content recognition algorithms, such as character recognition, to be applied to the received data. In another embodiment, the imaging system 210 can be used to scan and capture written content that already exists on the writing surface 50 (e.g., and not written using the smart pen 100). The imaging system 210 may further be used in combination with the pen down sensor 215 to determine when the marker 205 is touching the writing surface 50. As the marker 205 is moved over the surface, the pattern captured by the imaging array changes, and the user's handwriting can thus be determined and captured by a gesture capture system (e.g., the imaging system 210 in FIG. 2) in the smart pen 100. This technique may also be used to capture gestures, such as when a user taps the marker 205 on a particular location of the writing surface 50, allowing data capture using another input modality of motion sensing or gesture capture.

The imaging system 210 may further be used in combination with the pen down sensor 215 to determine when the marker 205 is touching the writing surface 50. As the marker 205 is moved over the surface, the pattern captured by the imaging array changes, and the user's handwriting can thus be determined and captured by the smart pen 100. This technique may also be used to capture gestures, such as when a user taps the marker 205 on a particular location of the writing surface 50, allowing data capture using another input modality of motion sensing or gesture capture.

Another data capture device on the smart pen 100 are the one or more microphones 220, which allow the smart pen 100 to receive data using another input modality, audio capture. The microphones 220 may be used for recording audio, which may be synchronized to the handwriting capture described above. In an embodiment, the one or more microphones 220 are coupled to signal processing software executed by the processor 245, or by a signal processor (not shown), which removes noise created as the marker 205 moves across a writing surface and/or noise created as the smart pen 100 touches down to or lifts away from the writing surface. In an embodiment, the processor 245 synchronizes captured written data with captured audio data. For example, a conversation in a meeting may be recorded using the microphones 220 while a user is taking notes that are also being captured by the smart pen 100. Synchronizing recorded audio and captured handwriting allows the smart pen 100 to provide a coordinated response to a user request for previously captured data. For example, responsive to a user request, such as a written command, parameters for a command, a gesture with the smart pen 100, a spoken command or a combination of written and spoken commands, the smart pen 100 provides both audio output and visual output to the user. The smart pen 100 may also provide haptic feedback to the user.

The speaker 225, audio jack 230, and display 235 provide outputs to the user of the smart pen 100 allowing presentation of data to the user via one or more output modalities. The audio jack 230 may be coupled to earphones so that a user may listen to the audio output without disturbing those around the user, unlike with a speaker 225. Earphones may also allow a user to hear the audio output in stereo or full three-dimensional audio that is enhanced with spatial characteristics. Hence, the speaker 225 and audio jack 230 allow a user to receive data from the smart pen using a first type of output modality by listening to audio played by the speaker 225 or the audio jack 230.

The display 235 may comprise any suitable display system for providing visual feedback, such as an organic light emitting diode (OLED) display, allowing the smart pen 100 to provide output using a second output modality by visually displaying information. In use, the smart pen 100 may use any of these output components to communicate audio or visual feedback, allowing data to be provided using multiple output modalities. For example, the speaker 225 and audio jack 230 may communicate audio feedback (e.g., prompts, commands, and system status) according to an application running on the smart pen 100, and the display 235 may display word phrases, static or dynamic images, or prompts as directed by such an application. In addition, the speaker 225 and audio jack 230 may also be used to play back audio data that has been recorded using the microphones 220.

The input/output (I/O) port 240 allows communication between the smart pen 100 and a computing system 120, as described above. In one embodiment, the I/O port 240 comprises electrical contacts that correspond to electrical contacts on the docking station 110, thus making an electrical connection for data transfer when the smart pen 100 is placed in the docking station 110. In another embodiment, the I/O port 240 simply comprises a jack for receiving a data cable (e.g., Mini-USB or Micro-USB). Alternatively, the I/O port 240 may be replaced by a wireless communication circuit in the smart pen 100 to allow wireless communication with the computing system 120 (e.g., via Bluetooth, WiFi, infrared, or ultrasonic).

A processor 245, onboard memory 250, and battery 255 (or any other suitable power source) enable computing functionalities to be performed at least in part on the smart pen 100. The processor 245 is coupled to the input and output devices and other components described above, thereby enabling applications running on the smart pen 100 to use those components. In one embodiment, the processor 245 comprises an ARM9 processor, and the onboard memory 250 comprises a small amount of random access memory (RAM) and a larger amount of flash or other persistent memory. As a result, executable applications can be stored and executed on the smart pen 100, and recorded audio and handwriting can be stored on the smart pen 100, either indefinitely or until offloaded from the smart pen 100 to a computing system 120. For example, the smart pen 100 may locally stores one or more content recognition algorithms, such as character recognition or voice recognition, allowing the smart pen 100 to locally identify input from one or more input modality received by the smart pen 100.

In an embodiment, the smart pen 100 also includes an operating system or other software supporting one or more input modalities, such as handwriting capture, audio capture or gesture capture, or output modalities, such as audio playback or display of visual data. The operating system or other software may support a combination of input modalities and output modalities and manages the combination, sequencing and transitioning between input modalities (e.g., capturing written and/or spoken data as input) and output modalities (e.g., presenting audio or visual data as output to a user). For example, this transitioning between input modality and output modality allows a user to simultaneously write on paper or another surface while listening to audio played by the smart pen 100, or the smart pen 100 may capture audio spoken from the user while the user is also writing with the smart pen 100.

In an embodiment, the operating system and applications support a sequence of independent and/or concurrent input and output modalities and seamless transitions between these modalities to provide for language learning. For example, a language learning (LL) application running on an operating system supporting modality independence, concurrence and sequencing might begin a lesson announcing that today is a lesson in writing, reading, speaking and listening to Chinese. The smart pen 100 might then animate the creation of a Mandarin character, drawing strokes of the character in proper order on the display 235, while simultaneously announcing the character's pronunciation via the speaker 225. The operating system would enable the simultaneous display and synchronized delivery of audio. The LL application might then prompt the user to draw each stroke of the character, following the animated display of each stroke on the display 225, thus sequencing the transition between modalities of visual output of information displayed on the smart pen 100, in a synchronized manner, with the input of stroke data by a user. As the user becomes more fluent with the creations of the character, and begins writing more rapidly, perhaps writing ahead of the strokes displayed, the OS will enable real time capture and interpretation of strokes and respond with proper displaying and audio as appropriate, engaging the user in a multimodal dialogue. As the user demonstrates proficiency in writing, and the smart pen 100 begins to be lead by the user, displaying strokes in response, rather than leading with strokes, the smart pen 100 might verbally compliment the user and request the user to speak the sound for the character during or after the stroke writing. As the user speaks the character sound, the smart pen 100 could record the sound and compare it to an exemplar. The smart pen 100 might then prompt the user by playing back the exemplar pronunciation and the user pronunciation, providing commentary and/or visual guidance regarding correctness in pronunciation The smart pen 100 might then prompt the user to listen, write, and speak, announcing a series of words one by one, waiting for the user to write and speak the words, while comparing the input speech and writing to exemplars, and redirecting the user to repeat writing or speaking as necessary.

In an extension of this example, the smart pen 100 might prompt the user to interact with a pre-printed Language Learning text or workbook. The smart pen 100 might move the user's attention among multiple displays, from text, to the workbook, to a user's notebook, while continuing a dialogue involving the smart pen 100 speaking and displaying independently or concurrently, directing the user to speak, write, and look at information independently or concurrently. Various other combinations of input modalities and output modalities, and sequencing, are also possible.

In an embodiment, the processor 245 and onboard memory 250 include one or more executable applications supporting and enabling a menu structure and navigation through a file system or application menu, allowing launch of an application or of a functionality of an application. For example, navigation between menu items comprises a dialogue between the user and the smart pen 100 involving spoken and/or written commands and/or gestures by the user and audio and/or visual feedback from the smart pen computing system. Hence, the smart pen 100 may receive input to navigate the menu structure from a variety of modalities.

For example, a writing gesture, a spoken keyword or a physical motion, may indicate that subsequent input is associated with one or more application commands. Input with a spatial and/or temporal component may also be used to indicate that subsequent data. Examples of input with a spatial input include two dots side-by-side. Examples of input with a temporal component include two dots written one immediately after the other. For example, a user may depress the smart pen 100 against a surface twice in rapid succession then write a word or phrase, such as “solve,” “send,” “translate,” “email,” “voice-email” or another predefined word or phrase to invoke a command associated with the written word or phrase or receive additional parameters associated with the command associated with the predefined word or phrase. Because these “quick-launch” commands can be provided in different formats, navigation of a menu or launching of an application is simplified. The “quick-launch” command or commands are preferably easily distinguishable during conventional writing and/or speech.

Alternatively, the smart pen 100 also includes a physical controller, such as a small joystick, a slide control, a rocker panel, a capacitive (or other non-mechanical) surface or other input mechanism which receives input for navigating a menu of applications or application commands executed by the smart pen 100.

### Example System Operation

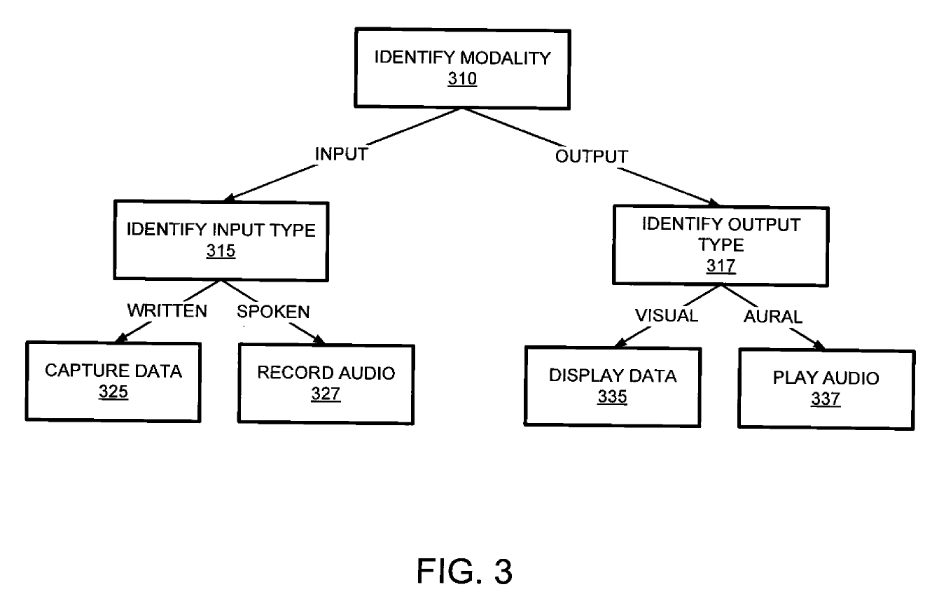

FIG. 3 is a flow chart of providing multiple modalities in a pen-based computing system in accordance with an embodiment of the invention. Those of skill in the art will recognize that other embodiments can perform the steps of FIG. 3 in different orders. Moreover, other embodiments can include different and/or additional steps than the ones described here.

Initially, the smart pen 100 identifies 310 a modality associated with a user interaction. In an embodiment, as the user interacts with the smart pen 100, such as by writing with the smart pen 100, moving the smart pen 100 or speaking to the smart pen 100. The smart pen 100 then identifies 310 a modality associated with one or more of the user interactions. For example, as the user writes with the smart pen 100, the imaging system 210 captures the written data which is subsequently processed by the processor 245 to determine whether a subset of the written data associated with an input modality or output modality. Similarly, audio data captured by the one or more microphones 220 is processed to determine whether a subset of the captured audio data is associated with an input or output modality. The smart pen 100 might begin to speak and allow for interruption by a user, to redirect the smart pen 100 behavior, prompting the smart pen 100 to replay audio, speed up or slow down playback, display information synchronized with the audio to enhance the value of audio information, bookmark or audio-tag information being communicated by the smart pen 100 or act in other ways in response to user input. This allows the smart pen 100 to identify commands or requests for input or output provided through various modalities, making user interaction with the smart pen 100 more intuitive and effective.

Responsive to determining that a user interaction is associated with an input modality, an input type is identified 315. By identifying 315 the input type, the smart pen 100 determines how input data is captured. Written data is captured 325 via the imaging system 210 and stored in onboard memory 250 as image or text data. Similarly, audio data is recorded 327 using the one or more microphones 220 and subsequently stored in the onboard memory 250. Hence, after identifying an input modality associated with a user interaction, the smart pen 100 captures additional data from interaction, such as written or spoken communication, with the smart pen 100.

The identified input type may be different than the user interaction which additionally identifies 310 the modality. For example, a user may provide a spoken command to the smart pen 100 to identify 310 an input modality and then begin writing with the smart pen 100, causing capture 325 of the written data. Similarly, a user may provide a written command, such as writing “record,” to identify 310 an input modality causing the smart pen 100 to record 327 subsequent audio data.

Responsive to determining that a user interaction is associated with an output modality, the output type is identified 317. By identifying 317 the output type, the smart pen 100 determines how to communicate information to the user. Textual data is displayed 335 via the display 235 or computing system 120. Similarly, audio data is played 337 using the speakers 225, audio jack 230 or computing system 120. Hence, after identifying an output modality associated with a user interaction, the smart pen 100 presents information or data to a user, such as by displaying visual data or playing audio data.

The identified output type may be different than the type of user interaction which initially identifies 310 the modality. For example, a user may provide a spoken command to the smart pen 100 identifying 310 an output modality causing the smart pen 100 to display 335 visual data. Similarly, a user may provide a written command, such as writing “playback,” which identifies 310 an output modality where the smart pen 100 plays previously captured audio data.

The identified output type may also be in the form of audio or visual feedback contextualized through interaction with an alternate input source. For example, a user could say or write “Translate to Spanish” or tap a printable surface printed with “Translate to Spanish”. The user could then tap English words printed in text or tap words previously written on paper to hear them spoken in Spanish from the smart pen 100 speaker or see them displayed in Spanish on the display 235. The user might then say, write or tap (a pre-printed button with) “Translate to Mandarin” and tap the same words to hear and/or see them in Mandarin. The smart pen 100 might also capture the words tapped to store and subsequently use them by testing the user's knowledge of the words or by sending them to a remote logging source.

### SUMMARY

The foregoing description of the embodiments of the invention has been presented for the purpose of illustration; it is not intended to be exhaustive or to limit the invention to the precise forms disclosed. Persons skilled in the relevant art can appreciate that many modifications and variations are possible in light of the above disclosure.

Some portions of this description describe the embodiments of the invention in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In one embodiment, a software module is implemented with a computer program product comprising a computer-readable medium containing computer program code, which can be executed by a computer processor for performing any or all of the steps, operations, or processes described.

Embodiments of the invention may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a tangible computer readable storage medium, which include any type of tangible media suitable for storing electronic instructions, and coupled to a computer system bus. Furthermore, any computing systems referred to in the specification may include a single processor or may be architectures employing multiple processor designs for increased computing capability.

Embodiments of the invention may also relate to a computer data signal embodied in a carrier wave, where the computer data signal includes any embodiment of a computer program product or other data combination described herein. The computer data signal is a product that is presented in a tangible medium or carrier wave and modulated or otherwise encoded in the carrier wave, which is tangible, and transmitted according to any suitable transmission method.

Finally, the language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based hereon. Accordingly, the disclosure of the embodiments of the invention is intended to be illustrative, but not limiting, of the scope of the invention, which is set forth in the following claims.

What is claimed is:

1. A smart pen device for interacting with a user using a plurality of modalities, the system comprising:
a processor;
a gesture capture system coupled to the processor and configured to capture handwriting data;
one or more microphones coupled to the processor and configured to capture audio data;
an onboard memory coupled to the processor and configured to store the captured handwriting data or captured audio data responsive to the processor identifying the input;
a display system coupled to the processor and configured to output display data stored in the onboard memory responsive to the processor identifying an output associated with the captured handwriting data or with the captured audio data;
an audio output system coupled to the processor and configured to play stored audio data responsive to the processor identifying an output associated with the captured handwriting data or with the captured audio data; and
computer program code stored on a memory and configured to be executed by the processor, the computer program code including instructions for identifying an input associated with the captured handwriting data or with the captured audio data, instructions for providing an output as display data to the display system or audio data to the audio output system.

2. The smart-pen device of claim 1, wherein the onboard memory comprises a random access memory coupled to a persistent memory.

3. The smart-pen device of claim 1, wherein the persistent memory comprises a flash memory.

4. The smart pen device of claim 1, wherein the computer program code further includes instructions for providing display data to the display system and audio data to the audio output system, wherein the display data and the audio data are related.

5. The smart pen device of claim 1, wherein the computer program code further includes instructions for concurrently providing display data to the display system and audio data to the audio output system.

6. The smart pen device of claim 1, wherein the display comprises an organic light emitting diode (OLED) display.

7. The smart pen device of claim 1, wherein the display comprises a computing system.

8. The smart pen device of claim 1, further comprising:
a pen down sensor coupled to the processor and the onboard memory, the pen down sensor determining a position of the smart pen, wherein the processor further identifies an output or an input associated with a change in the position of the smart pen.

9. The smart pen device of claim 8, wherein the pen down sensor further provides haptic feedback responsive to the processor identifying an output associated with the subset of the captured handwriting or with the subset of the captured audio.

10. A method for a pen-based computing system interacting with a user using a plurality of modalities, the method comprising:
receiving an interaction from the user;
associating a command with the interaction;
responsive to associating a voice capture command with the interaction, recording audio data and storing the recorded audio data in a smart pen;
responsive to associating a text capture command with the interaction, capturing handwriting data or text data proximate to the smart pen and storing the captured handwriting data or text data in the smart pen;
responsive to associating an audio playback command with the interaction, aurally presenting data to the user; and
responsive to associating a visual playback command with the interaction, visually presenting data to the user.

11. The method of claim 10, wherein the interaction comprises audio data, handwriting data, text data or a change in a position of the smart pen.

12. The method of claim 10, wherein the aurally presented data and the visually presented data are related.

13. The method of claim 10, wherein aurally presenting data to the user comprises:
playing audio data using the smart pen.

14. The method of claim 10, wherein visually presenting data to the user comprises:
visually displaying data on an output module.

15. The method of claim 10, further comprising:
responsive to associating a haptic command with the interaction, providing haptic feedback to the user.

16. A pen-based computing system for interacting with a user using a plurality of modalities, the system comprising:
a smart pen device configured to receive one or more user interactions;
computer program code stored on a memory and configured to be executed by a processor coupled to the smart pen device, the computer program code including instructions for identifying an input associated with a subset of the captured handwriting or with a subset of the captured audio data;
a storage device coupled to the processor and the smart pen, the storage device the onboard memory storing data associated with the smart pen device responsive to the processor identifying the input associated with a user interaction with the smart pen device; and
an output module coupled to the processor and to the storage device, the output module presenting stored data to the user responsive to the processor associating an output with the subset of the one or more user interactions with the smart pen device.

17. The pen-based computing of claim 16, wherein the output module comprises a speaker, the speaker playing audio associated with the stored data.

18. The pen-based computing of claim 16, wherein the output module comprises a display, the display visually presenting stored data to the user.

19. The pen-based computing system of claim 16, wherein the one or more user interactions comprise at least one of audio data, handwriting data, text data or a change in a position of the smart pen
